(19) United States
(12) Patent Application Publication
(10) Pub. No.: US 2021/0319601 A1
(43) Pub. Date: Oct. 14, 2021

(54) SYSTEM AND METHOD FOR CREATING PATENT DRAWINGS

(71) Applicants: Eric LEININGER, New Orleans, LA (US); Daniel LEININGER, New Orleans, LA (US); Louis TAYLOR, Arlington, VA (US)

(72) Inventors: Eric LEININGER, New Orleans, LA (US); Daniel LEININGER, New Orleans, LA (US); Louis TAYLOR, Arlington, VA (US)

(21) Appl. No.: 15/507,220

(22) PCT Filed: Aug. 28, 2015
(86) PCT No.: PCT/US15/47602

§ 371 Date: Sep. 14, 2019

Related U.S. Application Data
(60) Provisional application No. 62/044,080, filed on Aug. 29, 2014.

(51) Int. Cl. G06T 11/20; G06T 17/00; G06T 19/20

(52) U.S. Cl. CPC G06T 11/203; G06T 17/00; G06T 2219/004; G06T 2200/24; G06T 19/20

(57) ABSTRACT

This invention allows one to use a 3D model to create one or more patent drawings by using it to generate and annotate 2D images. It also allows for manipulation of the model via gesture and concatenated numbering of elements.

### CROSS-REFERENCE TO RELATED APPLICATIONS

Not applicable

### STATEMENT REGARDING FEDERALLY FUNDED RESEARCH

Not Applicable

### REFERENCE TO A MICROFICHE APPENDIX

Not applicable

### BACKGROUND OF THE INVENTION

### Field of the Invention/Technical Field

The present invention is in the technical field of business methods for intellectual property

### Description of Related Art/Background Art

In the age of the internet people's daily experiences are broadening. Widely available, instantly accessible information has led to a diversity of peoples unique experiences and with that, interactions within multiple arts in their daily lives. It is now possible for people without a formal education to began to have hyper-specialized skills across multiple arts (programming, communication, business) and this hyper specialization leads to opportunities and innovations that can rapidly grow economies, provide jobs and produce more efficient products and services than ever before. Patent protection is an important part of the comfort of these peoples to disclose their inventions to the world, in exchange for a limited exclusive marketplace opportunity.

Currently, preparing a patent application (in the US) is the work of about 40,000 professionals such as patent attorneys and patent agents. Rapid innovation is creating considerable demand for their services and method to accommodate this demand would greatly benefit their industry and society. However, there remain numerous impediments to the actual disclosure of inventions to the general public.

Patent practitioners often hire draftsmen to prepare patent applications which is expensive and time consuming. As they are generally difficult to prepare and have specific formatting and requirements that generally prevent a layperson from drafting effective documents required for a patent.

### SUMMARY OF THE INVENTION

It is an object of this invention to allow one to use a 3d model to create one or more patent drawings

It is yet another object of this invention to allow one to annotate snapped images of 3d drawings and relate that to elements in a patent application.

It is yet another object of this invention to have gesture control as a means to manipulate a 3d model cross section as an intuitive way to explore relevant internal elements in a 3d model. This is for the purpose of creating images of those internal components such that the patent drawing can have a complete disclosure of relevant parts.

It is yet another object of this invention to interact with a disclosure application such that numbering of elements can be concatenated. For example, by having an image array and that within each image there is a marker for the position of the instance element only (in a disclosure view). Back end systems may then concatenate these positions on a per element basis and sum the positions to create multiple element positions on juts one image file to be submitted as the drawing. PCT/US14/49510 is hereby incorporated by reference.

It is important for one to understand that this invention has been reduced to practice and numerous evidences of possession, function, capability and failed experiments (evidence of non-obvious combination as in this invention being functional) have been gathered by the inventor. Further, secondary evidences such as impact on the market place, use of the product by others, and enhanced capability for the inventor layperson are planned on being gathered after filing. In exchange for this public disclosure and the ultimate benefits of understanding how it works (which may be applicable to other processes besides patent applications), the inventor requests a brief exclusive right to sell (a patent) and continue to develop this invention rather than keeping it a trade secret.

### BRIEF DESCRIPTION OF THE DRAWINGS

FIG. 1 is a system diagram view that shows network communication of an embodiment of the invention.

FIG. 2 is a diagram view that shows relationship between modules and user devices.

FIG. 3 is a graphical user interface view that shows a module for uploading file to application.

FIG. 4 is a graphical user interface view that shows a module for examining and manipulating representative 3d model.

FIG. 5 is a graphical user interface view that shows a module for examining and manipulating representative 3d model.

FIG. 6 is a graphical user interface view that shows a module for selecting different 3d models that have been uploaded.

FIG. 7 is a graphical user interface view that shows module for selecting different sketches that have been uploaded.

FIG. 8 is a graphical user interface view that shows a module for selecting different snap shots of 3d models that have been created by a user.

FIG. 9 is a graphical user interface view that shows a module used for evaluating the snapshot of the 3d model that has been rendered in patent drawing acceptable format.

FIG. 10 is a graphical user interface view that shows a module used for tweaking the parameters of the snapshot of the 3d model that has been rendered in patent drawing acceptable format so that it is to the liking of the user.

FIG. 11 is a graphical user interface view that shows a disclosure application with one or more disclosure views nested to represent elements of an invention.

FIG. 12 is a graphical user interface view that shows a disclosure application with one or more disclosure views nested to represent elements of an invention with thumbnails of snaphots taken from 3d models, annotated with an X only where that specific element is on the snapshot.

FIG. 13 is a graphical user interface view that shows a module used for overlaying and manipulating the parameters of different 3d cross section models on top of the 3d model.

FIG. 14 is a graphical user interface view that shows a module with a flat plane cross section overlaying a 3d model.

FIG. 15 is a graphical user interface view that shows an example of using gesture control to control the flat plane cross section such that there is an intuitive means to examine all portions of the model using pitch, roll, yaw, and x,y,z parameters in the 3d space.

FIG. 16 is a graphical user interface view that shows a module with a cube cross section overlaying a 3d model.

FIG. 17 is a graphical user interface view that shows a module with a sphere cross section overlaying a 3d model.

FIG. 18 is a graphical user interface view that shows an example of a flat plane cross section preview generated while moving the cross section in 3d space.

FIG. 19 is a graphical user interface view that shows the generated cross section from the 3d plane cross section.

FIG. 20 is a graphical user interface view that shows an example of a sphere cross section preview generated while moving the sphere section in 3d space.

FIG. 21 is a graphical user interface view that shows the generated sphere section from the 3d sphere section.

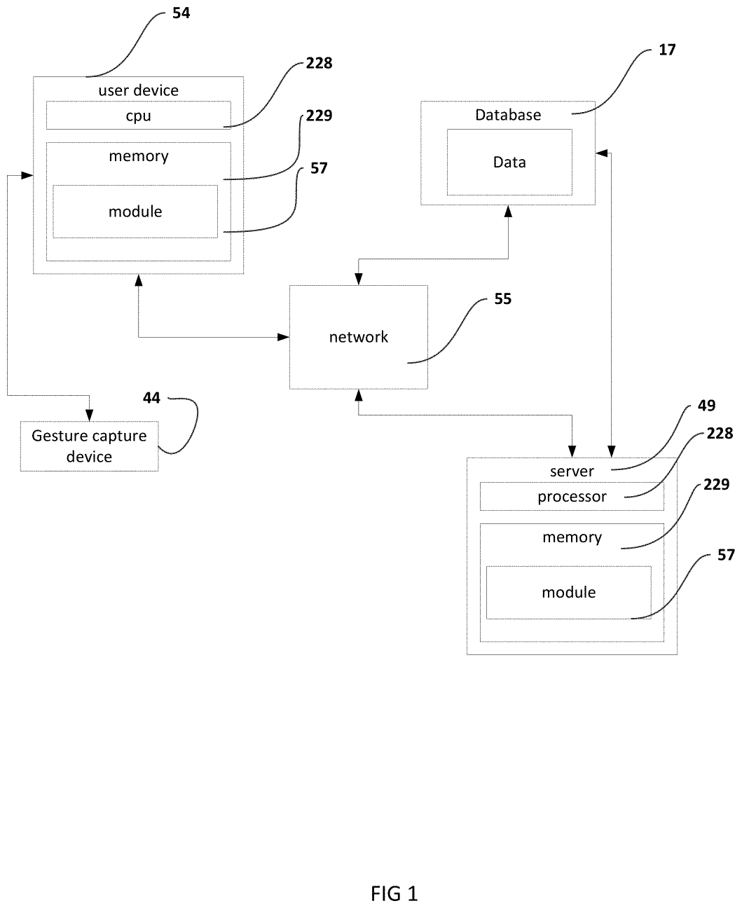

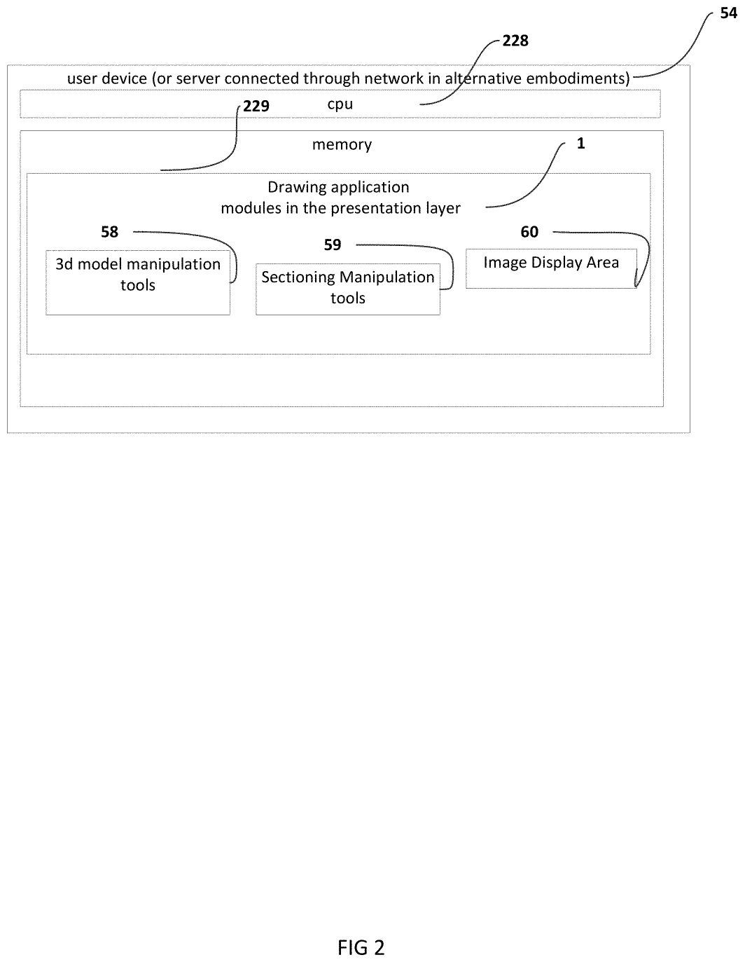

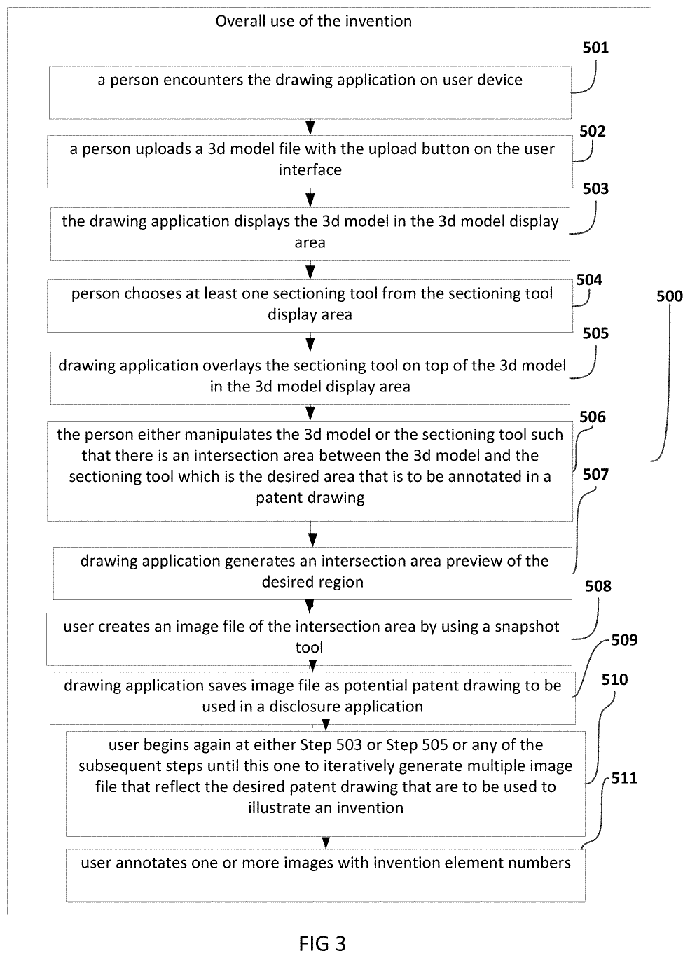

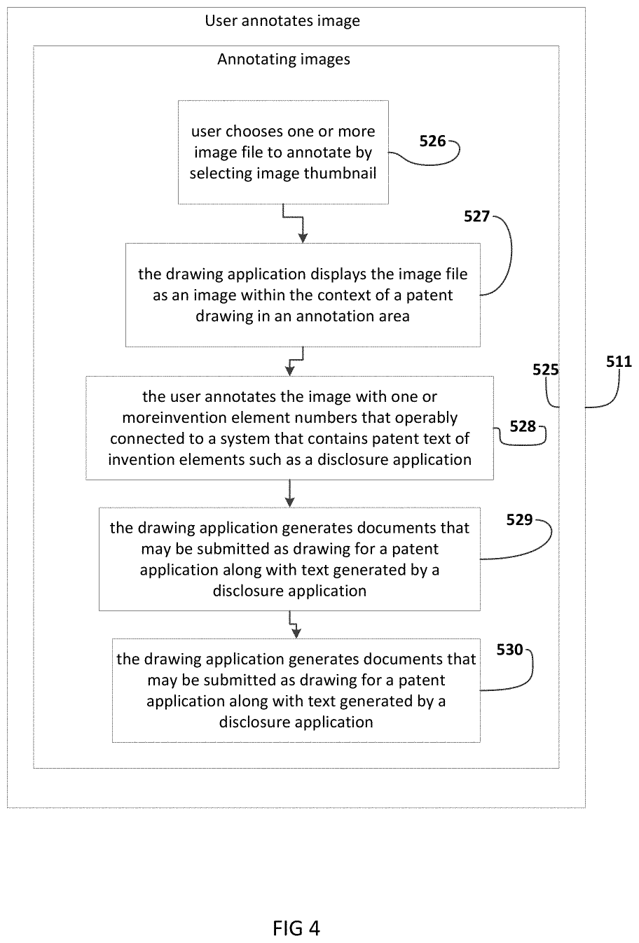

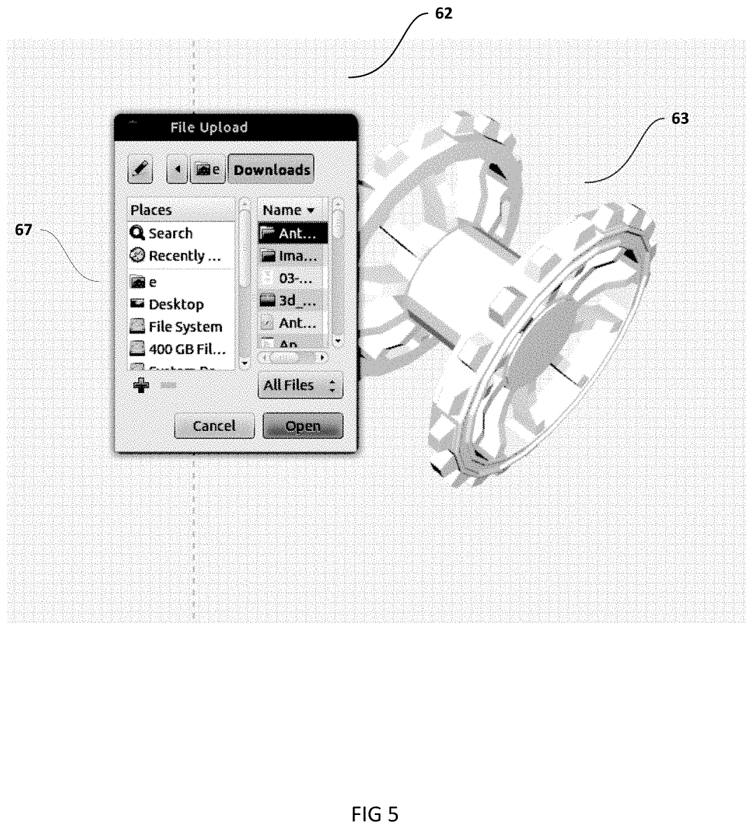

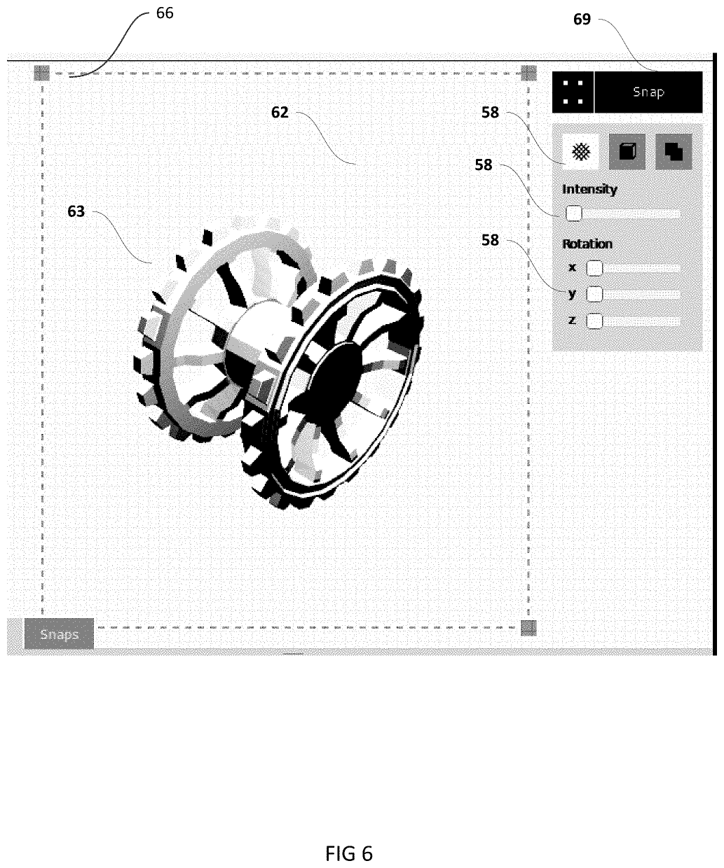

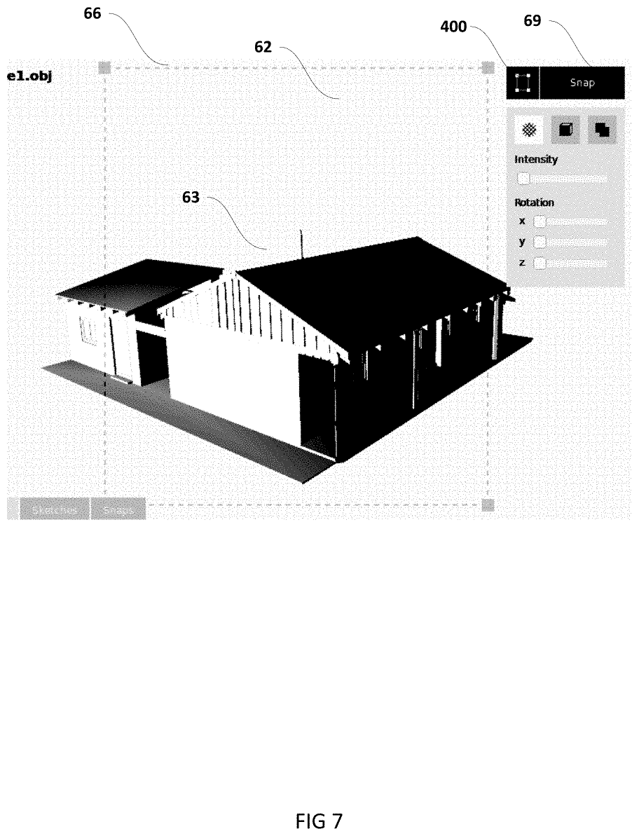

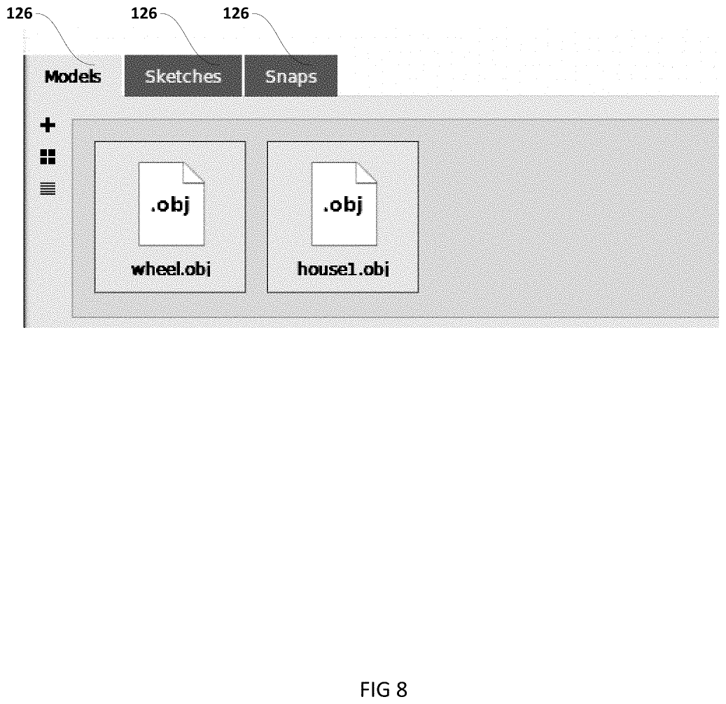

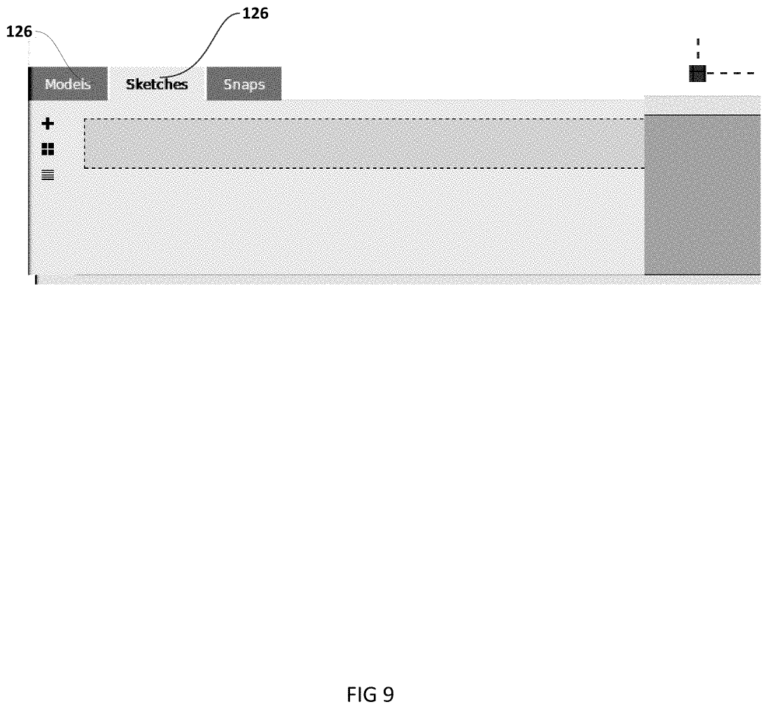

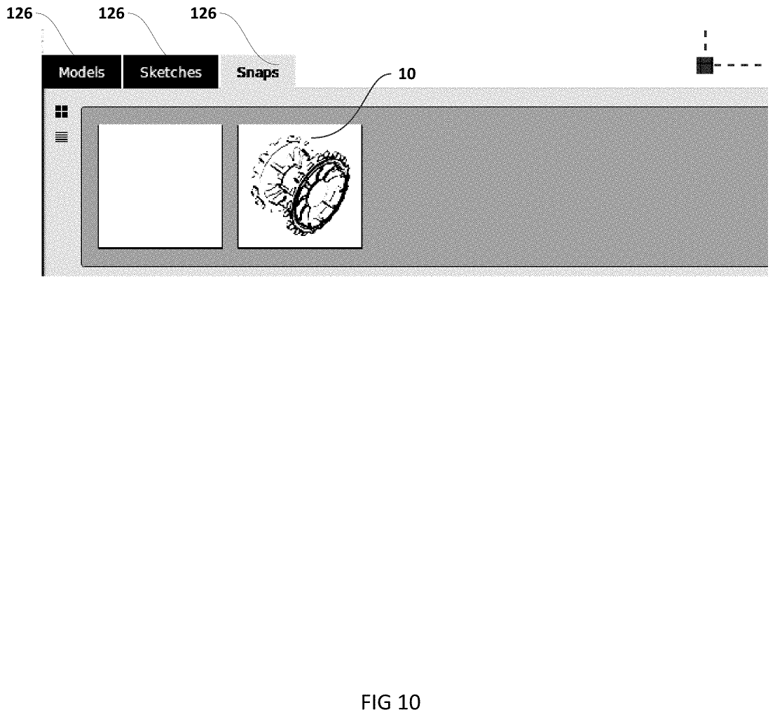

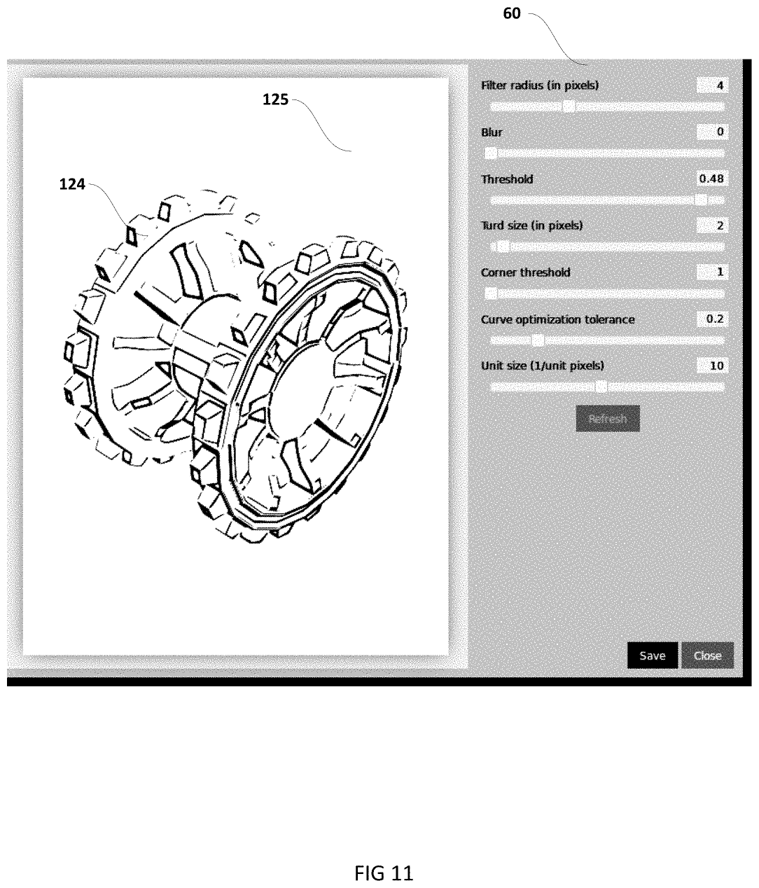

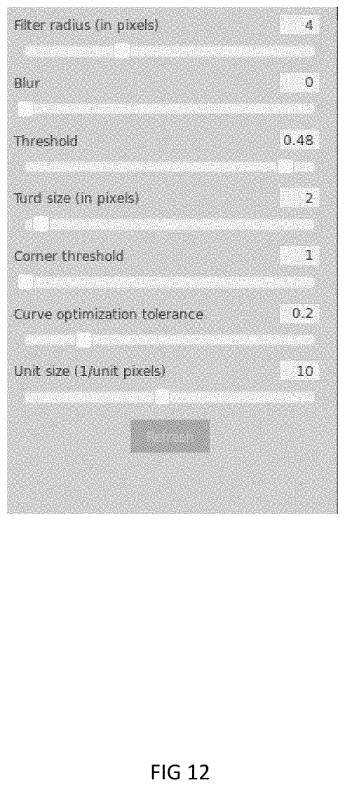

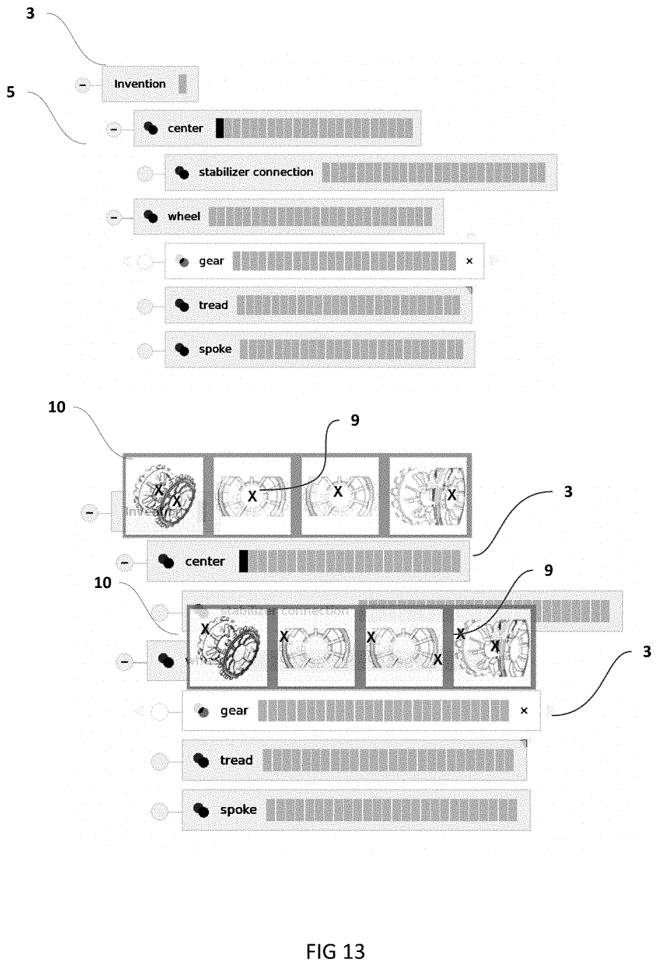

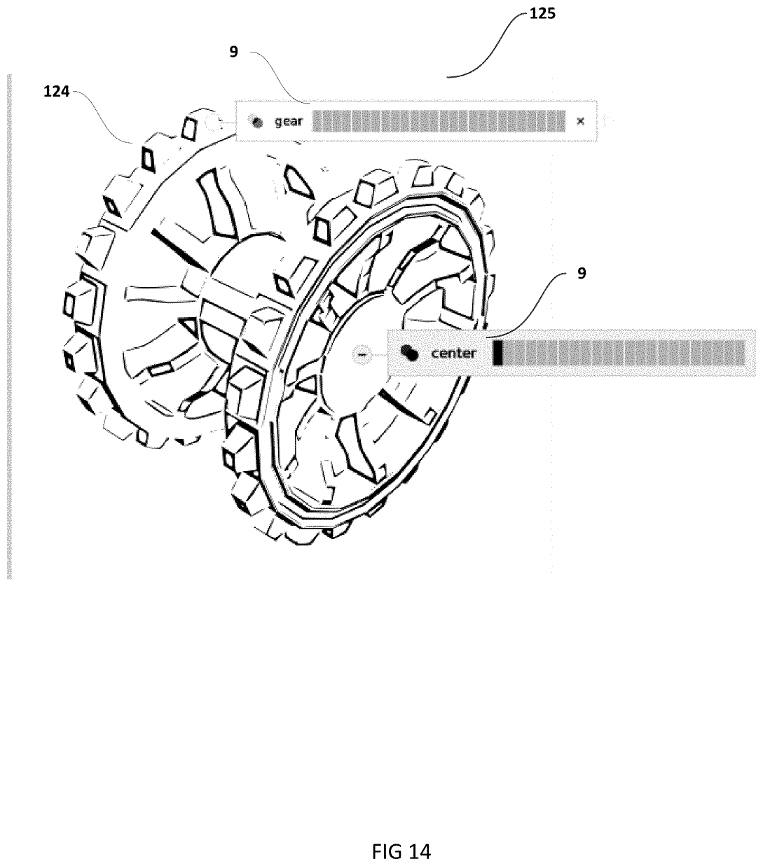

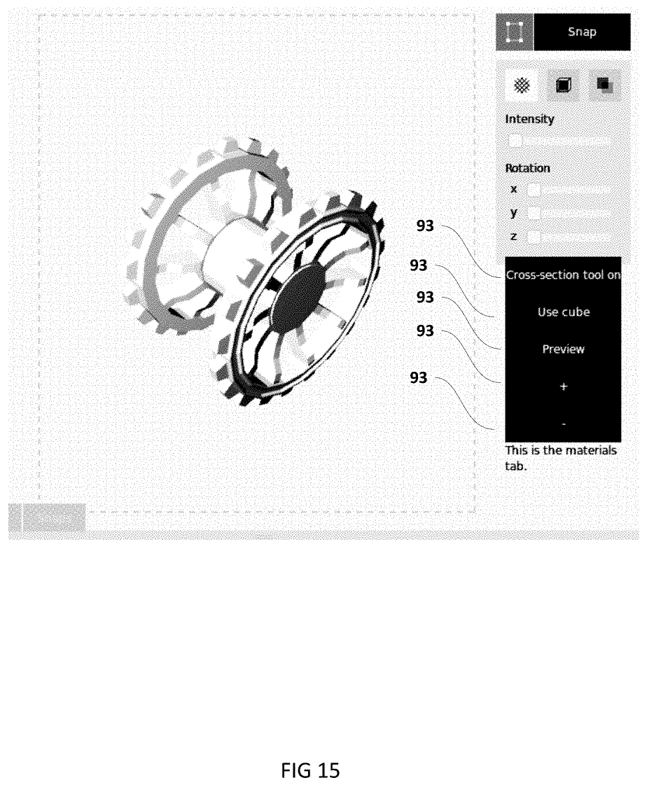

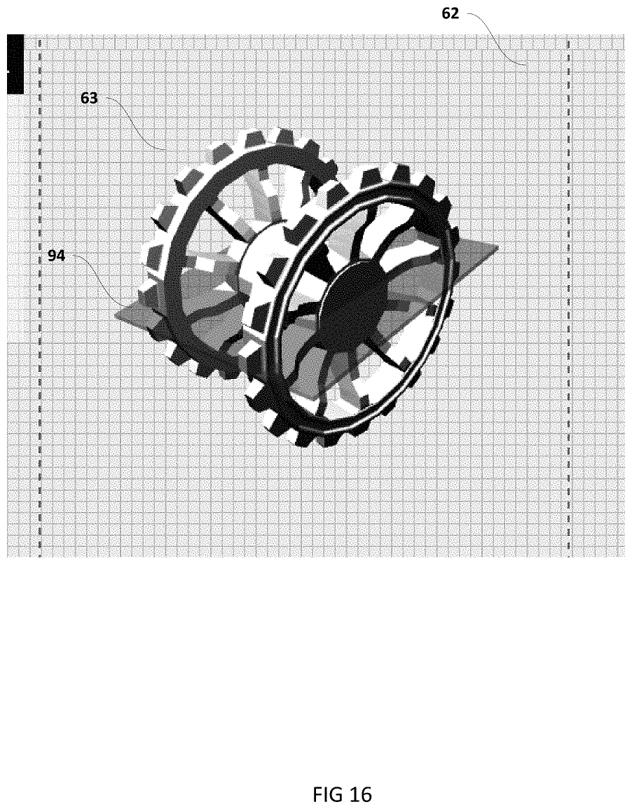

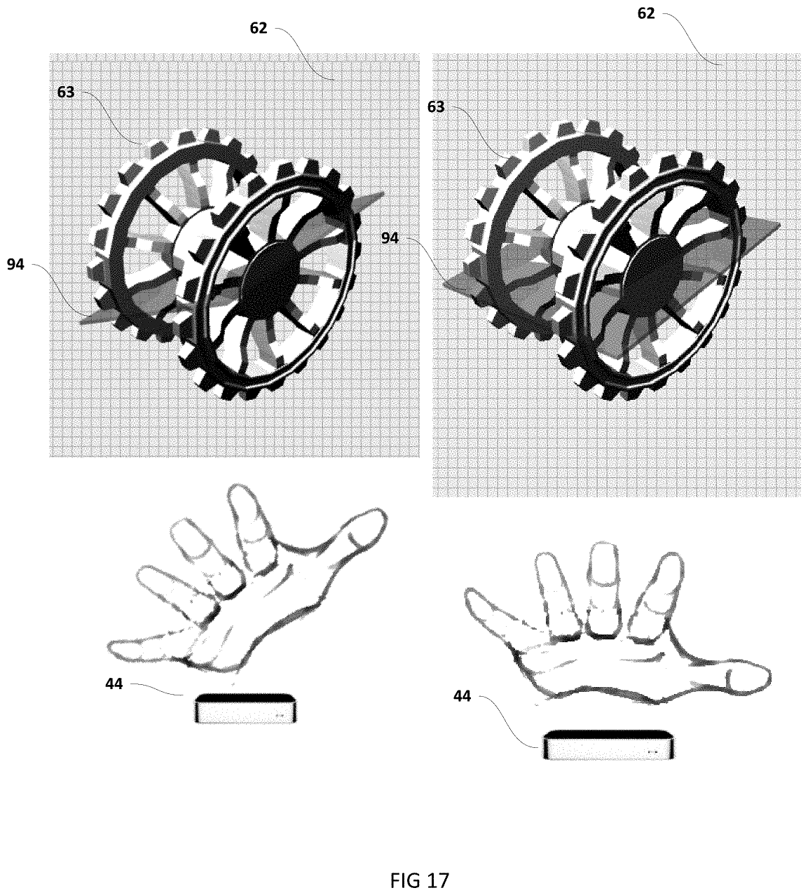

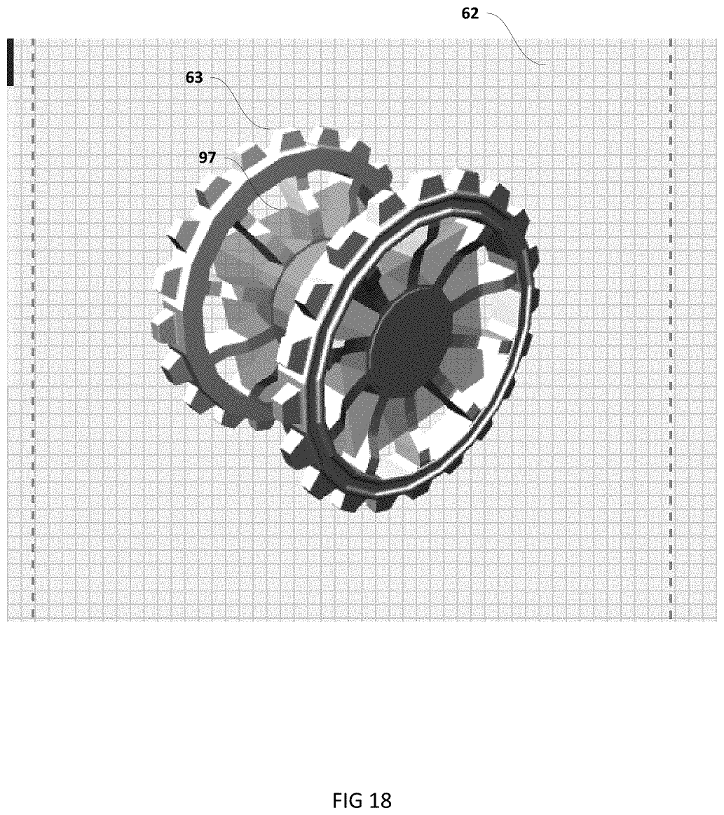

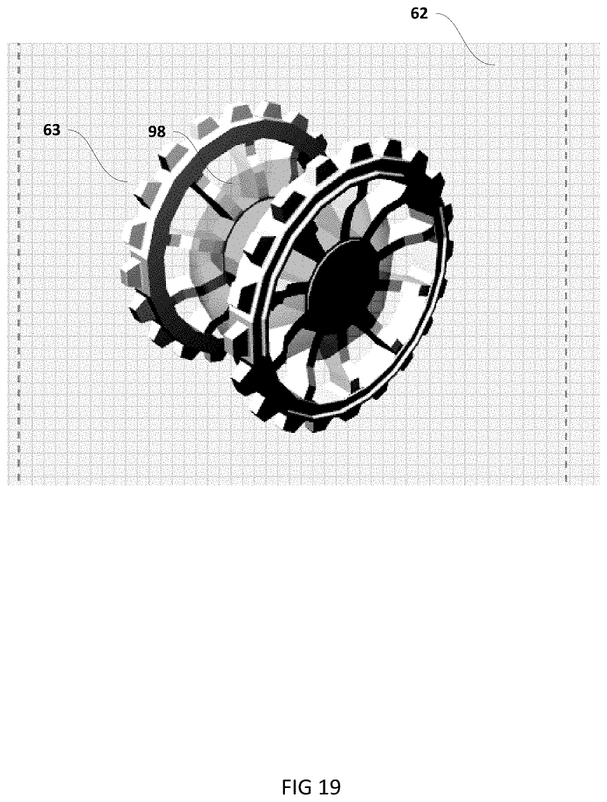

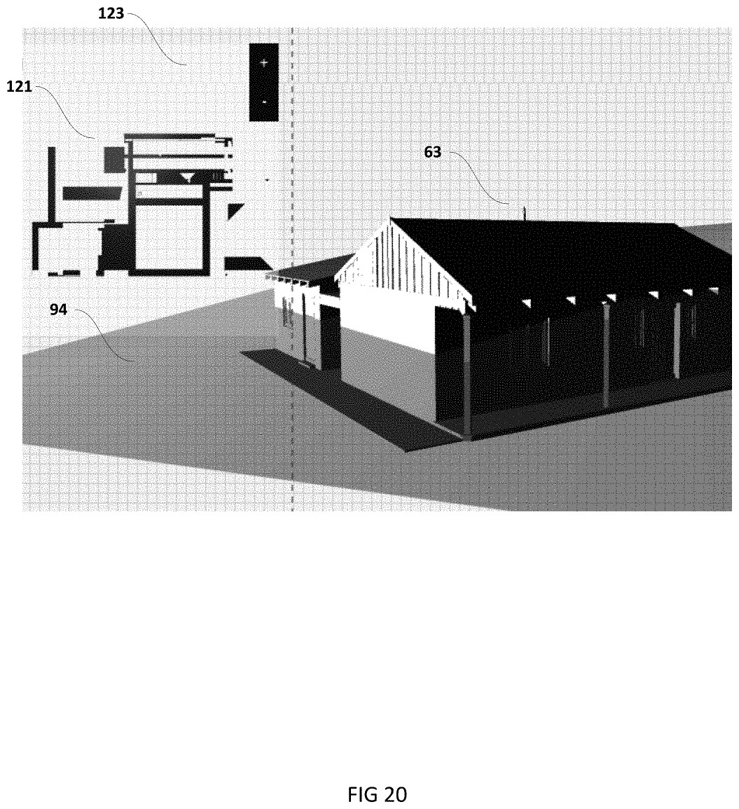

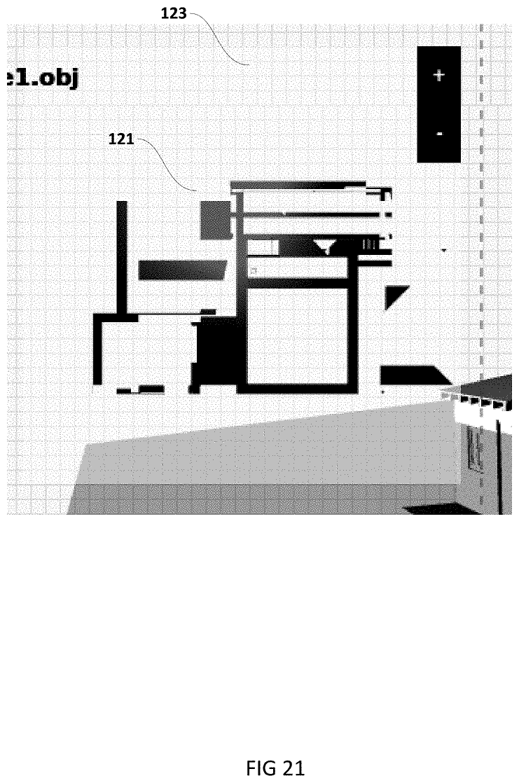

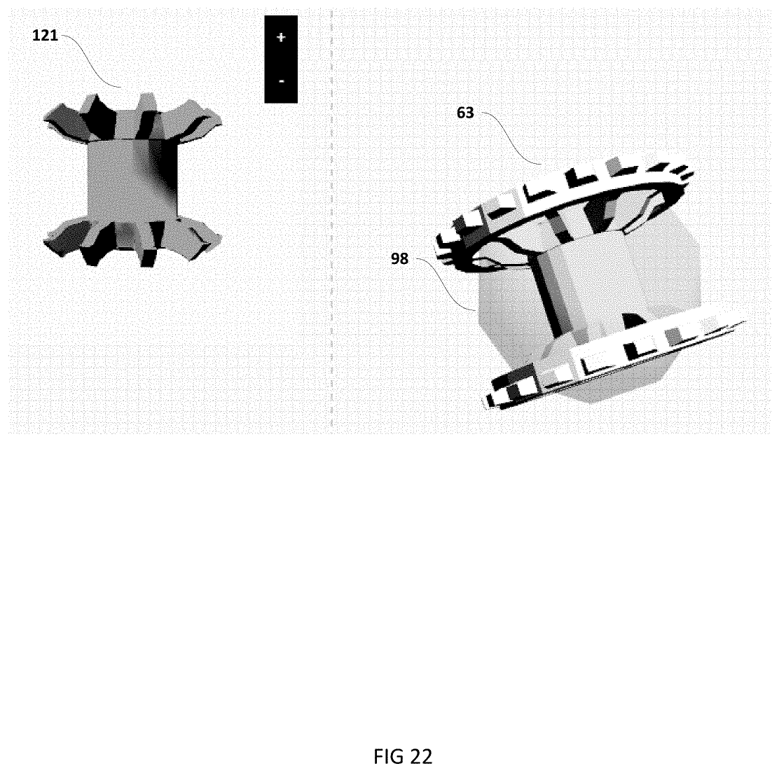

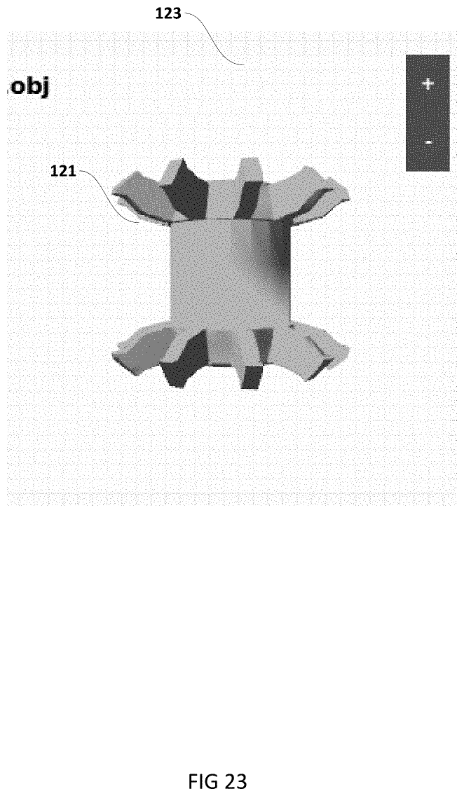

### DETAILED DESCRIPTION

In general it is thought that this invention is a novel computer program or portion of a program which allows rapid creation of patent drawings from images and 3d models. It may be standalone or integrated as part of a another program. As it is a computer program, it is thought that a person may use one or more devices, such as user device and server, to create the drawings. It is though that the user device and server may be any type of general computing device, such as a mobile computing device, laptop, netbook, server, cell phone, smart phone, personal digital assistant, tablet computer, or any other device capable of executing one or more instructions. The user device and server may contain one or more processors, such as processors which may be a central processing unit (cpu), a microprocessor, a general purpose processor, an application specific processor, or any device that executes instructions. The user device and server may also include one or more memories, that store data one or more software modules. The memory may be implemented using any computer-readable storage medium, such as hard drives, CDs, DVDs, flash memory, RAM, ROM, etc. The memory may store a module, or application, or interface, library or engine which may be executed by processor. The user interface may include one or more of a screen, a display, a projector, a touch panel, a pointing device, a scrolling device, a button, a switch, a motion sensor, an audio sensor, a pressure sensor, a thermal sensor, etc. which may interact with a presentaiton layer of a module. The presentation layer may include, derive information from or interact with one or more markup languages. For example, some embodiments may use a HTML 179, a XML 180, a XHTML 181, or a TeX 182 as a markup language 25. Some embodiments of a presentation layer may be a web browser 273, a stand alone application 274, a virtual reality headset, augmented reality glasses or overlays, or a messaging interface 275.

The user interface may allow one or more interfaces to present information to a user, such as a plan or intervention. The user interface may be web based, such as a web page, or a stand-alone application. The user interface may also be configured to accept information about a user, such as user feedback. The user may manually enter the information, or it may be entered automatically. The system may also include one or more data bases, such as database on a device or server. Database 102 may be implemented using any database technology known to one of ordinary skill in the art, such as relational database technology or object-oriented database technology. In addition, in some embodiments of the invention the user device is operably connected to a gesture capture device. It is reasonable to contemplate that the gesture capture device 44 may be wired gloves 200, depth-aware cameras 201, stereo cameras 202, controller-based gestures 203, or a single camera 204.

The invention has several sub steps for using it which are as follows: First, a person encounters the drawing application 1 on user device 54 (herein termed the Method (1)-Step(1) 501). Next, a person uploads a 3d model file 68 with the upload button 67 on the user interface 53, (herein termed the Method (1)-Step(2) 502). Next, drawing application 1 displays the 3d model 63 in the 3d model display area 62, (herein termed the Method (1)-Step(3) 503). Next, person chooses at least one sectioning tool 91 from the sectioning tool display area 90, (herein termed the Method (1)-Step(4) 504). Then, drawing application 1 overlays the sectioning tool 91 on top of the 3d model 63 in the 3d model display area 62, (herein termed the Method (1)-Step(5) 505). Next, person either manipulates the 3d model 63 or the sectioning tool 91 such that there is an intersection area 121 between the 3d model 63 and the sectioning tool 91 which is the desired area that is to be annotated in a patent drawing 46, (herein termed the Method (1)-Step(6) 506). Next, drawing application 1 generates an intersection area preview 123 of the desired region, (herein termed the Method (1)-Step(7) 507). Next, user creates an image file 124 of the intersection area 121 by using a snapshot tool 69, (herein termed the Method (1)-Step(8) 508). Next, drawing application 1 saves image file 124 as potential patent drawing 46 to be used in a disclosure application 5, (herein termed the Method (1)-Step(9) 509). Next, user begins again at either Step 503 or Step 505 or any of the subsequent steps until this one to iteratively generate multiple image file 124 that reflect the desired patent drawing 46 that are to be used to illustrate an invention, (herein termed the Method (1)-Step(10) 510). Last, user annotates one or more images with invention element numbers 9, (herein termed the Method (1)-Step(11) 511). Another embodiment of the invention may use a step where a person uploads a image file 124 with the upload button 67 on the user interface 53, herein termed as method (1)-step(12) 512, instead of Step 502. Another embodiment of the invention may send the drawings to a receiving office. For example, the receiving office 37 could be either a United States Patent and Trademark Office 183, a European Patent Office 184, or a Japan Patent Office 185 (or others). The aforementioned method is herein termed Method (1) 500. While the steps in Method (1) 500 are depicted in a particular order, the principles of the present disclosure are not limited to the order depicted immediately above. Additionally, embodiments of the Method (1) 500 process can include more or less steps than those depicted.

The Step 511 has several sub steps for using it which are as follows: user chooses one or more image file 124 to annotate by selecting image thumbnail 10 (herein termed the Method (2)-Step(1) 526 Next, drawing application 1 displays the image file 124 as an image within the context of a patent drawing 46 in an annotation area 125, (herein termed the Method (2)-Step(2) 527). Then, user annotates the image with one or more invention element numbers 9 that operably connected to a system that contains patent text of invention elements 15 such as a disclosure application 5, (herein termed the Method (2)-Step(3) 528). Finally, drawing application 1 generates documents that are submitted as drawing for a patent application along with text generated by a disclosure application 5, (herein termed the Method (2)-Step(4) 529). The aforementioned method is herein termed Method (2) 525. In another embodiment of the invention there may be a step where one may use an disclosure application 5 which displays an array of image thumbnail 10 representative of patent drawing 46 superimposed over one or more disclosure view 3, herein termed as method (2)-step(5) 530, instead of Step 527. While the steps in Method (2) 525 are depicted in a particular order, the principles of the present disclosure are not limited to the order depicted immediately above. Additionally, embodiments of the Method (2) 525 process can include more or less steps than those depicted.

In general, the drawing application 1 preferably comprises 3 sub-parts; the 3d model manipulation tools 58, the sectioning manipulation tools 59, and the image display area 60. The term drawing application 1 is broadly thought to include a program 22 or module 57 that is accessible in a client-server model over a network 55.

In more detail, the 3d model manipulation tools 58 preferably comprise 8 elements; the 3d model display area 62, the 3d model 63, the 3d object model 64, the 3d model controls 65, the snapshot frame 66, the upload button 67, the 3d model file 68, and the snapshot tool 69. The term 3d model manipulation tools is broadly thought to include the user interface interactive components that allow management of the files and display of a 3d model. The term 3d model may include a mathematical representation of a three-dimensional object which allows it to be displayed as a two dimensional image. The term 3d object model is broadly thought to include the 3d model that a user wishes to create patent drawings with, which is sectioned by one or more sectioning tool (used interchangeably with 3d model in this specification text. The term 3d model file is thought to encompass a file type that contains the information that allows a program to display a 3d model.

Some intentions of the 3d model display area 62 are to both 1) have an interactive area to drag the model to change the angle and 2) have an adjustable area size to examine the 3d model 63. The term 3d model display area is thought to encompass a region of the user interface which presents a 3d model as a two dimensional image that can be manipulated by the user.

Adjacent to this area is the 3d model controls. Some objectives of the 3d model controls 65 are to both 1) have an interactive area to drag the model to change the angle and 2) give one the ability to change the zoom state. The term 3d model controls is thought to encompass a sequence of instructions executed by the central processing unit 167 that allows changing of the camera, angle, size, zoom, presentation, rendering, shading or instance image of the 3d model in the 3d model display area on the user interface.

Additionally, within the group of tools there is a snapshot frame. The snapshot frame 66 functions to have a way that the user can select different portions of a 3d model 63 in order to create the image file 124. The snapshot frame 66 is positionally situated, peripheral to the 3d model display area 62 and can be rotated into portrait and landscape orientations, (though other orientations are possible) with the orientation button 400. The term snapshot frame 58 is thought to encompass a frame that surrounds the 3d model display area 54 that is used to set the boundaries for the image file 116 that is generated by the snapshot tool 61.

Additionally, the tools comprise an upload button. One objective of the upload button 67 is to have a means to upload a 3d model file 68. The term upload button may include an interface component that functions to allow a 3d model file to be transferred over a network to a server where the drawing application is located.

Further, the model tools comprises a snapshot tool. The snapshot tool 69 functions to have a means to decide that the position of the 3d model 63 in the 3d model display area 62 is a good representation for a patent drawing 46 and implement a series of instructions to create an image file of that instance position. The term snapshot tool is broadly thought to include a sequence of instructions executed by the cpu that captures the displayed image on a computer and creates an image file of that displayed image.

Another module houses the sectioning manipulation tools. The term sectioning manipulation tools is broadly thought to include a means for manipulating sectioning tool in order to get a cross section image file. The sectioning manipulation tools 59 preferably comprises 4 elements; the sectioning tool display area 90, the sectioning tool 91, the sectioning tool controls 92, and the intersection tools 93. The term sectioning tool is thought to encompass one or more 3d model provided by the drawing application that is a volume that interacts with an uploaded d model such that a 3d model of the intersection area can be identified and used as an image for a patent drawing. The term sectioning tool display area may include a region of the user interface which displays one or more sectioning tool which can be selected by the user to create an intersection area with a 3d model.

In more detail, the sectioning tool 91 comprises 3 components, respectively referred to as the cross-section tool 94, the volume section tool 95, and the inverse volume section tool 96. The cross-section tool 94 is intended to iteratively examine or capture the section of a 3d model 63 examine or capture a volume of a 3d model 63 in the intersection area preview 123. The term cross-section tool is thought to encompass a sectioning tool that appears as a flat plane to the user. In turn, the volume section tool 95 has two items, the square section tool 97 and the sphere-section tool 98. The volume section tool 95 is designed to iteratively examine or capture a volume of a 3d model 63 in the intersection area preview 123. The term volume section tool is broadly thought to include a sectioning tool that is a manipulable volume that crops (removes details outside the tool) a portion of a 3d model. Further, one objective of the inverse volume section tool 96 is to iteratively examine or capture the volume of a 3d model 63 in the intersection area preview 123 that does not intersect with the sectioning tool 91. The term square section tool may include a sectioning tool that appears as a square to the user and allows the user to crop a portion of the uploaded 3d model. The term sphere-section tool is thought to encompass a sectioning tool that appears as a sphere to the user and allows the user to crop a portion of the uploaded 3d model. The term inverse volume section tool is thought to encompass a sectioning tool that is a manipulable volume that inverse crops (removes the area of the tool) the 3d model.

The sectioning tool controls 92 allows one to manipulate one or more sectioning tool preferably comprises has two sub-parts, the mouse or button manipulation tools 99 and the gesture manipulation tools 100. The term sectioning tool controls is thought to encompass a sequence of instructions executed by the central processing unit that allows changing of the camera, angle, size, zoom, presentation, rendering, shading or instance image of the sectioning tool in the 3d model display area on the user interface. The mouse or button tools are generally means to control the sectioning tool and it is reasonable to contemplate that in some embodiments either a sectioning mouse zoom 101, a sectioning mouse rotate 102, a sectioning mouse pan 103, a sectioning mouse fly 104, a sectioning rotate tool 105, a sectioning spin tool 106, a sectioning pan tool 107, a sectioning zoom tool 108, a sectioning fly tool 109, a sectioning size tool 110, or a sectioning thickness tool 111 may take the place of the mouse or button manipulation tools 99. In addition there may be gesture manipulation tools, which allow one to control the section tool through body motions. The gesture manipulation tools 100 are designed to allow the user an intuitive means to implement sectioning tool controls when attempting to create an intersection area. The term gesture manipulation tools is broadly thought to include controls operably connected to a gesture capture device that translates the user movement into moving the sectioning tool.

The intersection tools 93 is comprised of 3 sub-members, called the intersection area 121, the intersection processor 122, and the intersection area preview 123. The term intersection tools may include the components necessary to create and display the interaction between the 3d model and one or more sectioning tool. The term intersection area is broadly thought to include a generated 3d model that is the end result of the intersection processor being applied to the sectioning tool and the d object model present in the 3d model display area. The term intersection processor is thought to encompass a sequence of instructions executed by the cpu that allows boolean operations between two or more 3d model such as finding the intersection between two 3d models, adding, and subtracting 3d models (or the inverse of said operations). The term intersection area preview may include a generated 3d model that is the end result of the intersection processor being applied to the sectioning tool and the d object model present in the 3d model display area that is iteratively projected as the sectioning tool is moved.

The image display area 60 preferably comprises 3 accompanying sub-parts; the image file 124, the annotation area 125, and the image evaluation tools 126. The term image display area is broadly thought to include an area where an image file is displayed for use by the drawing application. The term image file is thought to encompass standardized means of organizing and storing digital images composed of digital data that can be rasterized for use on a computer display or printer. In some embodiments, it is reasonable to contemplate that the image file 124 may of the type: iff 127, ham 128, lbm 129, img 130, image 131, jpg 132, pic 133, pix 134, png 135, psd 136, rgb 137, sgi 138, bw 139, rgba 140, inta 141, tif 142, tiff 143, tga 144, targa 145, bmp 146, dib 147, or svg 148.

The image evaluation tools 126 are designed to have a means to evaluate a lot of images simultaneously in order to choose or manipulate one or more of the subset of images. The term image evaluation tools 126 may include a part of the graphical user interface 231 that hosts multiple images for evaluation or selection such as an array of image thumbnail 10.

The invention comprises numerous terms that are necessary to define the scope of for purposes of interpretation. The definition of these terms below allows numerous embodiments of the invention that may arise, rather than just the preferred embodiment as described above. The term drawing application 1 is broadly thought to include a program 22 or module 57 that is accessible in a client-server model over a network 55. The term 3d model manipulation tools 58 may include the user interface 53 interactive components that allow management of the files and display of a 3d model.

The term 3d model display area 62 is broadly thought to include a region of the user interface 53 which presents a 3d model 63 as a two dimensional image that can be manipulated by the user. The term 3d model 63 is broadly thought to include a mathematical representation of a three-dimensional object which allows it to be displayed as a two dimensional image. The term 3d object model 64 is thought to encompass the 3d model 63 that a user wishes to create patent drawings with, which is sectioned by one or more sectioning tool 91 (used interchangeably with 3d model 63 in this specification text.

The term 3d model controls 65 is thought to encompass a sequence of instructions executed by the central processing unit 228 that allows changing of the camera, angle, size, zoom, presentation, rendering, shading or instance image of the 3d model 63 in the 3d model display area 62 on the user interface 53. The term snapshot frame 66 is thought to encompass a frame that surrounds the 3d model display area 62 that is used to set the boundaries for the image file 124 that is generated by the snapshot tool 69. The term upload button 67 may include an interface component that functions to allow a 3d model file 68 to be transferred over a network 55 to a server 49 where the drawing application 1 is located.

The term 3d model file 68 may include a file 2 type that contains the information that allows a program 22 to display a 3d model 63. The term snapshot tool 69 may include a sequence of instructions executed by the cpu 51 that captures the displayed image on a computer 50 and creates an image file 124 of that displayed image. The term sectioning manipulation tools 59 is broadly thought to include a means for manipulating sectioning tool 91 in order to get a cross section of an image file 124 to create a patent drawing 46.

The term sectioning tool display area 90 is thought to encompass a region of the user interface 53 which displays one or more sectioning tool 91 which can be selected by the user to create an intersection area 121 with a 3d model 63. The term sectioning tool 91 is thought to encompass one or more 3d model 63 provided by the drawing application 1 that is a volume that interacts with an uploaded 3d model 63 such that a 3d model 63 of the intersection area 121 can be identified and used as an image for a patent drawing 46. The term cross-section tool 94 is broadly thought to include a sectioning tool 91 that appears as a flat plane to the user.

The term volume section tool 95 is thought to encompass a sectioning tool 91 that is a manipulable volume that crops (removes details outside the tool) a portion of a 3d model 63. The term square section tool 97 is broadly thought to include a sectioning tool 91 that appears as a square to the user and allows the user to crop a portion of the uploaded 3d model 63. The term sphere-section tool 98 is thought to encompass a sectioning tool 91 that appears as a sphere to the user and allows the user to crop a portion of the uploaded 3d model 63.

The term inverse volume section tool 96 is thought to encompass a sectioning tool 91 that is a manipulable volume that inverse crops (removes the area of the tool) the 3d model 63. The term sectioning tool controls 92 may include a sequence of instructions executed by the central processing unit 228 that allows changing of the camera, angle, size, zoom, presentation, rendering, shading or instance image of the sectioning tool 91 in the 3d model display area 62 on the user interface 53. The term gesture manipulation tools 100 is thought to encompass controls operably connected to a gesture capture device 44 that translates the user movement into moving the sectioning tool 91.

The term intersection tools 93 is broadly thought to include the components necessary to create and display the interaction between the 3d model 63 and one or more {[sectioning_tool}}. The term intersection area 121 is thought to encompass a generated 3d model 63 that is the end result of the intersection processor 122 being applied to the sectioning tool 91 and the 3d object model 64 present in the 3d model display area 62. The term intersection processor 122 may include a sequence of instructions executed by the cpu 51 that allows boolean operations between two or more 3d model 63 such as finding the intersection between two 3d models, adding, and subtracting 3d models (or the inverse of said operations).

The term intersection area preview 123 is broadly thought to include a generated 3d model 63 that is the end result of the intersection processor 122 being applied to the sectioning tool 91 and the 3d object model 64 present in the 3d model display area 62 that is iteratively projected as the sectioning tool 91 is moved. The term image display area 60 is broadly thought to include an area where an image file 124 is displayed for use by the drawing application 1. The term image file 124 may include standardized means of organizing and storing digital images composed of digital data that can be rasterized for use on a computer display or printer.

The term annotation area 125 is thought to encompass a part of the graphical user interface 231 that is designated for a snapshot figure to be annotated with markers representing patent elements. The term image evaluation tools 126 may include a part of the graphical user interface 231 that hosts multiple images for evaluation or selection such as an array of image thumbnail 10. The term file 2 is thought to encompass a resource for storing information, which is available to a computer program and is usually based on some kind of durable storage.

The term disclosure view 3 may include a part of a disclosure application 5 that is an interactive view 31 within a graphical user interface 231 that is draggable and a crud object 36. The term 3d model file 4 is broadly thought to include a file 2 type that contains the information that allows a program 22 to display a 3d model 63. The term disclosure application 5 is thought to encompass software 24 or module 57 in a presentation layer 56 on a user device 54 that allows rapid, input of invention information 38 and outputs patent application text.

The term inventor 6 is broadly thought to include any person, or persons in United States patent law, who contribute to the claims of a patentable invention. The term patent application 7 is thought to encompass a request pending at a patent office for the grant of a patent for the invention described and claimed within the application. The term element association 8 may include the nested relationship between one or more disclosure view 3 (of possibly different types, such as method having steps or step having sub step or step having element) which may determine different type of sentences generated.

The term invention element numbers 9 may include views similar to markers, that are draggable and crud object 36 where a disclosure application 5 or drawing application 1 may generate numbers and organize the numbering that correspond elements in a patent drawing 46. The term image thumbnail 10 may include a smaller representative image of a larger image, used for rapidly evaluating multiple images when grouped or design. The term presentation layer 56 is thought to encompass graphical output from a module 57 for user interaction typically one or more graphical user interface 231.

The term module 57 is broadly thought to include instructions hosted on memory 229 executed by the cpu 51 which perform functions. The term natural text 14 may include text generated from the invention that describes the inventor 6 invention. The term invention elements 15 is broadly thought to include one or more element 34.

The term disclosure data 16 is broadly thought to include the instance or sum result of input into one or more disclosure view 3 translated into a structured data format that can be queried or parsed. The term database 17 is broadly thought to include an organized collection of data with a software system designed to allow the definition, creation, querying, update, and administration of databases. The term client server model 18 is thought to encompass structure in computing that partitions tasks or workloads between the providers of a resource or service, called servers, and service requesters, called clients.

The term server side 19 may include operations that are performed by the server in a client-server relationship in computer networking. The term server 49 is broadly thought to include a system (software and suitable computer hardware) that responds to requests across a computer network and has a cpu 51 capable of executing one or more instructions on one or module 57 present on memory 229. The term computer network 21 is thought to encompass a telecommunications network that allows computers to exchange data.

The term program 22 is broadly thought to include a sequence of instructions, written to perform a specified task with a computer that is executed by the central processing unit 228. The term cpu 51 is broadly thought to include hardware within a computer that carries out the instructions of a computer program by performing the basic arithmetical, logical, and input/output operations of the system. The term software 24 is broadly thought to include a collection of computer programs and related data.

The term markup language 25 is thought to encompass a modern system for annotating a document in a way that is syntactically distinguishable from the text. The term website 26 is broadly thought to include a set of related web pages served from a single web domain. The term client 27 is thought to encompass a piece of computer hardware or software that accesses a service made available by a server.

The term web browser 28 is broadly thought to include a software application for retrieving, presenting and traversing information resources on the internet. The term web page 29 may include a web document that is suitable for the internet and the web browser. The term programming language 30 may include an artificial language designed to communicate instructions to a machine, particularly a computer.

The term disclosure 32 may include a traditional document written by an inventor or ally of an inventor, or an interactive program 22 such as the disclosure application 5 which may include one or more instances of invention information 38 for describing an invention. The term disclosure data format 33 is thought to encompass a data format used for storing one or more element 34 of invention information 38, this may be a markup language 25 or file, for example. The term element 34 is thought to encompass an item in an invention that can possibly have sub-items (which are not solely limitations).

The term drawing representative relationship 35 is thought to encompass a relationship that represents a disclosure view 3 as superimposed over the patent drawing 46 as the part 41 or step 40, wherein the disclosure view 3 resembles a numbered element and lead line in a patent drawing 46. The term crud object 36 is thought to encompass an acronym for create, read, update and delete graphical user interface 231 objects which are the four basic functions of persistent storage. Also pertains to graphical user interface 231 conventions that facilitate viewing, searching, and changing information for computer 50 forms and reports. The term invention information 38 may include data related to the function, composition, creation, use, or description of an invention including any claimable limitation.

The term user input 52 is thought to encompass text or information that is input by the user into one or more module 57 presentation layer 56. The term step 40 is thought to encompass an action that is performed in an invention. The term part 41 is broadly thought to include a functional physical component of an invention.

The term user interface 53 may include a display mechanism for a graphical user interface 231 which in turn is part of the presentation layer 56 of one or more module 57. The term user device 54 is thought to encompass an interactive device that has a cpu 51 and memory 229 with one or more module 57 containing executable instructions, typically a computer 50. The term gesture capture device 44 may include a device that has the ability to track a person&#x27;s movements and determine what gestures they may be performing through algorithmic and/or software means.

The term network 55 may include a telecommunications network that allows computers to exchange data. The term patent drawing 46 is thought to encompass a drawing required for ascertaining intellectual property, for example which may be a non provisional patent drawing 47 or a provisional patent drawing 48. The term non provisional patent drawing 47 is broadly thought to include a drawing that is labeled with numbers representing invention elements or steps or tables that corresponds to the requirements of drawings for the USPTO non provisional application or PCT application.

The term provisional patent drawing 48 may include a drawing that is labeled with numbers representing invention elements or steps or tables that is used for filing a provisional patent. The term server 49 is thought to encompass a system (software and suitable computer hardware) that responds to requests across a computer network and has a cpu 51 capable of executing one or more instructions on one or module 57 present on memory 229. The term computer 50 is broadly thought to include a general purpose device that can be programmed to carry out a finite set of arithmetic or logical operations.

The term central processing unit 228 is thought to encompass hardware within a computer that carries out the instructions of a computer program by performing the basic arithmetical, logical, and input/output operations of the system. The term memory 229 is thought to encompass the physical devices used to store programs (sequences of instructions) or data (e.g. program state information) on a temporary or permanent basis for use in a computer or other digital electronic device. The term operating system 230 is broadly thought to include a collection of software that manages computer hardware resources and provides common services for computer programs.

The term graphical user interface 231 is thought to encompass a type of user interface that allows users to interact with electronic devices through graphical icons and visual indicators such as secondary notation, as opposed to text-based interfaces, typed command labels or text navigation. The term cpu 51 may include hardware within a computer that carries out the instructions of a computer program by performing the basic arithmetical, logical, and input/output operations of the system. The term user input 52 is broadly thought to include text or information that is input by the user into one or more module 57 presentation layer 56.

The term user interface 53 is thought to encompass a display mechanism for a graphical user interface 231 which in turn is part of the presentation layer 56 of one or more module 57. The term user device 54 may include an interactive device that has a cpu 51 and memory 229 with one or more module 57 containing executable instructions, typically a computer 50. The term network 55 is broadly thought to include a telecommunications network that allows computers to exchange data.

The term presentation layer 56 is broadly thought to include graphical output from a module 57 for user interaction typically one or more graphical user interface 231. The term module 57 is broadly thought to include instructions hosted on memory 229 executed by the cpu 51 which perform functions.

1) We claim a system for creating drawings comprising:
a computer with a microprocessor,
an interface on said computer,
a means to upload a 3d model to said interface
a means to take one or more instance image of a 3d model in a particular orientation
a means for annotating one or more of said instance image and operably relating annotation positions to elements in a patent drawing

2) We claim a method for creating drawings comprising:
uploading a 3d model to a computer
taking one or more instance image of a 3d model in a particular orientation annotating one or more of said instance image and operably relating annotation positions to elements in a patent drawing
